(19) United States
(12) Patent Application Publication
(10) Pub. No.: US 2011/0305621 A1
(43) Pub. Date: Dec. 15, 2011

(54) Method Of Continuously Producing Tetrafluorosilane By Using Various Fluorinated Materials, Amorphous Silica And Sulfuric Acid

(76) Inventors: Kyung Hoon Kang, Suwon-si (KR); Yeon Seok Cho, Suwan-si (KR); Se Jong Kim, Seongnam (KR)

(21) Appl. No.: 12/989,618

(22) PCT Filed: Sep. 9, 2010
(86) PCT No.: PCT/KR10/06136

§ 371 Date: Oct. 25, 2010

(30) Foreign Application Priority Data
Jun. 11, 2010 (JP) 10-2010-0055401

(51) Int. Cl. C01B 33/107

(52) U.S. Cl. 423/342

(57) ABSTRACT

The present invention relates to a method of continuously producing tetrafluorosilane (SiF₄) by using various fluorinated materials, amorphous silica (SiO₂) and sulfuric acid (H₂SO₄). According to the present invention, the yield of tetrafluorosilane can increase and it can be continuously produced in an environmentally friendly manner with low cost. In addition, the amount of hydrogen fluoride generated during the reaction is minimized and thus the corrosion of devices can be minimized, and the pipeline blockage and yield decrease of SiF₄ can be prevented by passing the reaction product which is a mixture gas of SiF₄ and water through an H₂SO₄ scrubber at a high temperature to remove water, which can prevent the generation of silica gel and hexafluorosilicic acid by the side-reaction of condensed water and SiF₄.

### TECHNICAL FIELD

The present invention relates to a method of continuously producing tetrafluorosilane (SiF₄) by using various fluorinated materials, amorphous silica (SiO₂) and sulfuric acid (H₂SO₄). More specifically, the present invention relates to a method of producing tetrafluorosilane by reacting in a single reactor (i) a fluoride source material capable of reacting with sulfuric acid to generate hydrogen fluoride (HF), (ii) amorphous silica and (iii) sulfuric acid; and then passing the obtained gaseous product through an H₂SO₄ scrubber. According to the present invention, the yield of tetrafluorosilane can increase and it can be continuously produced in an environmentally friendly manner with low cost by using various fluorinated materials other than hydrogen fluoride. In addition, the amount of hydrogen fluoride (i.e., hydrofluoric acid) generated during the reaction is minimized and thus the corrosion of devices can be minimized, and the pipeline blockage and yield decrease of SiF₄ can be prevented by passing the reaction product which is a mixture gas of tetrafluorosilane (SiF₄) and water through an H₂SO₄ scrubber at a high temperature to remove water, which can inhibit the generation of silica gel and hexafluorosilicic acid (H₂SiF₆) by the side-reaction of condensed water and SiF₄.

### BACKGROUND ART

Tetrafluorosilane (SiF₄) has been used in the semiconductor manufacturing industry as a fluorine-doping agent for optical fibers based on quartz, a raw material of photomask for semiconductor lithography and in chemical vapor deposition (CVD) for semiconductor manufacturing. Its purity has grown in importance as the integration level of electronic devices and their performance have gotten higher. Recently, tetrafluorosilane has become a very important basic material, increasingly needed as a precursor of monosilane (SiH₄), which is a raw material for preparing polysilicon for solar cells, or the like.

Tetrafluorosilane is known to be prepared by the thermal dehydration reaction of hexafluorosilicic acid (H₂SiF₆) concentrate, which is conventionally generated as a by-product in the production of phosphate fertilizer, with sulfuric acid (WO 2005/030642) or by the thermal decomposition reaction of the solid salt of hexafluorosilicic acid (M₂SiF₆, wherein M=Na, K) prepared from hexafluorosilicic acid (U.S. Pat. No. 2,615,872). However, since these conventional methods thermally decompose hexafluorosilicic acid generated as a by-product of phosphate fertilizer production, for the scale-up of tetrafluorosilane production, the process for phosphate fertilizer production has to be modified or scaled up.

U.S. Pat. No. 4,382,071 suggests a method for producing tetrafluorosilane by reacting hydrogen fluoride dissolved in sulfuric acid with silica. However, this method has a problem in that hydrogen fluoride should be preliminarily prepared since it is used as a starting material.

U.S. Pat. No. 6,770,253 suggests a method for producing tetrafluorosilane by reacting metallurgical silicon (Si) with hydrogen fluoride (HF) at a high-temperature condition such as 300° C. or higher. However, this method has a problem in that the production cost is high because the metallurgical silicon (Si) powder as used is very expensive.

### DISCLOSURE OF INVENTION

### Technical Problem

To resolve the problems of prior arts as explained above, the present invention has an object of providing a method of producing tetrafluorosilane wherein hydrogen fluoride and tetrafluorosilane can be produced continuously in a single reactor, by which the yield of tetrafluorosilane can increase and thus the amount of unreacted hydrogen fluoride is minimized and accordingly the corrosion of devices can be minimized, and thus tetrafluorosilane can be produced at low cost in an environmentally friendly manner, and in addition, the pipeline blockage and yield decrease of SiF₄ can be prevented by inhibiting the generation of silica gel and hexafluorosilicic acid (H₂SiF₆) by the side-reaction of water and SiF₄.

### Solution to Problem

To achieve the object as explained above, the present invention provides a method of producing tetrafluorosilane comprising the steps of: (1) reacting in a single reactor (i) a fluoride source material capable of reacting with sulfuric acid to generate hydrogen fluoride (HF), (ii) amorphous silica and (iii) sulfuric acid; and (2) passing the obtained gaseous product of step (1) through an H₂SO₄ scrubber.

### Advantageous Effects of Invention

According to the present method, hydrogen fluoride generated by the reaction of the fluoride source material and sulfuric acid can effectively react with the amorphous silica, and thus the amount converted to tetrafluorosilane can be maximized. Also, the effective removal of water from the reaction product inhibits the generation of silica gel and hexafluorosilicic acid (H₂SiF₆), which is a by-product of the reaction of water and SiF₄, and thus the pipeline blockage problem in the process and yield decrease of SiF₄ do not occur. Furthermore, the excellent reaction efficiency minimizes the amount of unreacted hydrogen fluoride, and thus the process can be operated safely from the corrosion of devices thereby. In addition, sodium aluminum tetrafluoride (NaAlF₄), which is a by-product generated in monosilane production, or the like can be used as the fluoride source material in the present method, and for the silica, by-products of other industrial processes such as silica fume, cullet, Diatomaceous earth, kaolin, fumed silica, fly ash, slag, activated clay, silica gel, etc. can be used as raw materials. Accordingly, the present method can be operated under more preferred conditions in terms of environmental friendliness and economy.

### BRIEF DESCRIPTION OF DRAWINGS

FIG. 1 is a schematic FIGURE for an embodiment of a rotary kiln reaction facility to continuously perform the method of producing tetrafluorosilane according to the present invention.

### MODE FOR THE INVENTION

The present invention is explained in detail below.

In the present method of producing tetrafluorosilane, a material which can generate hydrogen fluoride (HF) by the reaction with sulfuric acid is used as the fluoride source material. Examples of such fluoride source material include sodium aluminum tetrafluoride (NaAlF₄), chiolite (Na₅Al₃F₁₄.2AlF₃), cryolite (Na₃AlF₆), calcium fluoride (CaF₂), sodium fluoride (NaF), aluminum fluoride (AlF₃), etc. and mixtures thereof. Each of the above fluoride source materials reacts with sulfuric acid to generate hydrogen fluoride according to the following reaction formulas, respectively.

NaAlF₄+2H₂SO₄→4HF+NaAl(SO₄)₂ Reaction Formula 1

CaF₂+H₂SO₄→2HF+CaSO₄ Reaction Formula 2

Na₅Al₃F₁₄·2AlF₃+10H₂SO₄→20HF+5NaAl(SO₄)₂ Reaction Formula 3

Na₃AlF₆+3H₂SO₄→6HF+Na₃Al(SO₄)₃ Reaction Formula 4

2NaF+H₂SO₄→2HF+Na₂SO₄ Reaction Formula 5

2AlF₃+3H₂SO₄→6HF+Al₂(SO₄)₃ Reaction Formula 6

That is, when reacting with sulfuric acid, sodium aluminum tetrafluoride is converted to sodium aluminum sulfate (NaAl(SO₄)₂, Reaction Formula 1), calcium fluoride is converted to calcium sulfate (CaSO₄, Reaction Formula 2), chiolite is converted to sodium aluminum sulfate (NaAl(SO₄)₂, Reaction Formula 3), cryolite known as belonging to the monoclinic system is converted to sodium aluminum sulfate (Na₃Al(SO₄)₆, Reaction Formula 4), sodium fluoride is converted to sodium sulfate (Na₂SO₄, Reaction Formula 5) and aluminum fluoride is converted to aluminum sulfate (Al₂(SO₄)₃, Reaction Formula 6), generating hydrogen fluoride.

In the present method of producing tetrafluorosilane, the purity of the fluoride source material is 90% or more (e.g., 90 to 99%), preferably 93% or more (e.g., 93 to 99%) and more preferably 95% or more (e.g., 95 to 99%), based on weight. The particle size of the fluoride source material properly ranges from 10 to 2,000 μm, preferably from 40 to 1,700 μm and more preferably from 50 to 1,500 μm.

Among the above fluoride source materials, as the sodium aluminum tetrafluoride compound, the present method can use a by-product generated during the process for preparing monosilane by reacting tetrafluorosilane (SiF₄) gas with sodium aluminum tetrahydride (NaAlH₄) as a reducing agent as shown in the following Reaction Formula 7, or a product prepared by mechanically milling a mixture of aluminum trifluoride (AlF₃) and sodium fluoride (NaF), preferably at high temperature, as shown in the following Reaction Formula 8.

SiF₄+NaAlH₄→SiH₄+NaAlF₄ Reaction Formula 7

AlF₃+NaF→NaAlF₄ Reaction Formula 8

In the present method of producing tetrafluorosilane, silica in amorphous form is used as the silicon source. Examples of such amorphous silica include silica fume, which is a microsilica particle obtained by collecting and filtering the gaseous material generated in the production of ferrosilicon and silicon metal; cullet, which is generated in the glass-production process and conventionally broken or discarded; Diatomaceous earth, which is a kind of soft rock and soil made from diatom's body; kaolin, which mainly consists of kaolinite and halloysite and is formed from feldspar through chemical weathering by carbonic acid and water; fumed silica, which is prepared by the pyrolysis reaction of silicon tetrachloride or the like; fly ash, which is coal cinder collected by using a dust collector from a chimney gas of a boiler for burning pulverized coal; slag, which is the remainder after the abstraction of metal from ore; activated clay which is a porous material and also used as an adsorbent; silica gel; etc. and mixtures thereof.

In the present method of producing tetrafluorosilane, the content of SiO₂ in the amorphous silica raw material conventionally ranges from 25 to 100% based on weight, and may vary according to concrete materials.

Silica fume has an SiO₂ content ranging conventionally from 80 to 99%, preferably from 85 to 99% and more preferably from 90 to 99% by weight, and a particle size ranging conventionally from 10 to 500 μm, preferably from 20 to 300 μm and more preferably from 50 to 200 μm.

Diatomaceous earth has an SiO₂ content ranging conventionally from 80 to 99% and preferably from 85 to 99% by weight, and a particle size ranging conventionally from 10 to 2,000 μm, preferably from 30 to 1,700 μm and more preferably from 50 to 1,500 μm.

Cullet has an SiO₂ content ranging conventionally from 60 to 90% and preferably from 80 to 90% by weight, and a particle size ranging conventionally from 10 to 2,000 μm, preferably from 10 to 1,500 μm and more preferably from 10 to 1,000 μm.

Kaolin has an SiO₂ content ranging conventionally from 60 to 90%, preferably from 70 to 90% and more preferably from 80 to 90% by weight, and a particle size ranging conventionally from 10 to 1,000 μm, preferably from 10 to 800 μm and more preferably from 50 to 700 μm.

Fumed silica has an SiO₂ content ranging conventionally from 60 to 100%, preferably from 70 to 100% and more preferably from 80 to 100% by weight, and a particle size ranging conventionally from 10 to 500 μm, preferably from 10 to 300 μm and more preferably from 50 to 200 μm.

Fly ash has an SiO₂ content ranging conventionally from 60 to 90%, preferably from 70 to 90% and more preferably from 80 to 90% by weight, and a particle size ranging conventionally from 10 to 500 μm, preferably from 10 to 300 μm and more preferably from 50 to 200 μm.

For the slag, iron slag, copper slag or both may be used. Slag has an SiO₂ content ranging conventionally from 20 to 40%, preferably from 25 to 40% and more preferably from 30 to 40% by weight, and a particle size ranging conventionally from 10 to 500 μm, preferably from 10 to 300 μm and more preferably from 50 to 200 μm.

Activated clay has an SiO₂ content ranging conventionally from 50 to 90%, preferably from 60 to 90% and more preferably from 65 to 90% by weight, and a particle size ranging conventionally from 10 to 500 μm, preferably from 10 to 300 μm and more preferably from 50 to 200 μm.

Silica gel has an SiO₂ content ranging conventionally from 50 to 100%, preferably from 60 to 100% and more preferably from 65 to 100% by weight, and a particle size ranging conventionally from 10 to 2,000 μm, preferably from 30 to 1,700 μm and more preferably from 50 to 1,500 μm.

In the present method of producing tetrafluorosilane, the purity of sulfuric acid used ranges from 80 to 100%. Sulfuric acid is used in an amount of 1 to 5 times, preferably 1 to 3 times and more preferably 1 to 2 times the theoretically equivalent amount required to be reacted with the fluoride source material as explained above.

The present method of producing tetrafluorosilane is typically carried out in a rotary kiln reactor in a continuous manner. To increase the reaction efficiency, a kneader reactor may be added before the kiln reactor, or the inner space of the kiln reactor may be designed to have a dual-tube structure. An inner screw may be placed therein to pulverize and disperse bulky solids, by which the reactivity can increase. The reaction has a two-step mechanism consisting of: the first reaction step of generating hydrogen fluoride by reacting sulfuric acid and the fluoride source material; and the second reaction step of producing tetrafluorosilane by reacting the generated hydrogen fluoride and silica fed thereto continuously. Examples of the first reaction step include reactions using various fluorinated compounds such as Reaction Formulas 1 to 6 above. Examples of the second reaction step include the reaction of HF generated in the kiln and a raw material of silica (SiO₂) such as the following Reaction Formula 9.

4HF+SiO₂→SiF₄+2H₂O Reaction Formula 9

HF gas generated in the kiln by the first reaction step should react with a raw material of silica (SiO₂) and convert to SiF₄ before it is discharged from the kiln. For this, the present invention uses amorphous silica having a good reactivity with HF—i.e., silica fume, cullet, Diatomaceous earth, kaolin, fumed silica, fly ash, slag, activated clay, silica gel and the like.

The reaction temperature inside the kiln reactor is 150 to 800° C., preferably 200 to 700° C. and more preferably 250 to 600° C., and the reaction is carried out under the operation pressure inside the kiln reactor of at least −1,000 mmH₂O in order to smoothly transfer the gas generated by the reaction. The upper limit of the operation pressure is not especially limited, and thus the reaction may be carried out under the condition of atmospheric pressure or higher.

After the second reaction step, the generated gaseous product containing SiF₄, water and a small amount of HF gas is passed through a sulfuric acid (H₂SO₄) scrubber in which water and HF are removed, and the purified product of SiF₄ is obtained. The purified SiF₄ is then transferred to a storage tank and stored therein. According to an embodiment of the present invention, the H₂SO₄ scrubber is operated at a temperature condition of preferably 10 to 150° C. and more preferably 10 to 100° C. The gaseous product coming out of the reactor, which is a high-temperature mixture gas of SiF₄, water vapor (H₂O) and a small amount of HF, is preferably transferred from the reactor to the H₂SO₄ scrubber while maintaining the temperature at its dew point or higher (preferably 100° C. or higher, for example, 100 to 200° C.). If the transfer temperature is lower than the dew point, moisture may be generated by the condensation of water vapor and the moisture may react with SiF₄ to form silica gel or H₂SiF₆, which can cause pipeline blockage and a yield decrease due to loss of tetrafluorosilane (the following Reaction Formulas 10 and 11, respectively).

SiF₄(g)+2H₂O(l)→SiO₂(s, silica gel)+4HF(g) Reaction Formula 10

2HF(aq)+SiF₄(g)→H₂SiF₆(aq) Reaction Formula 11

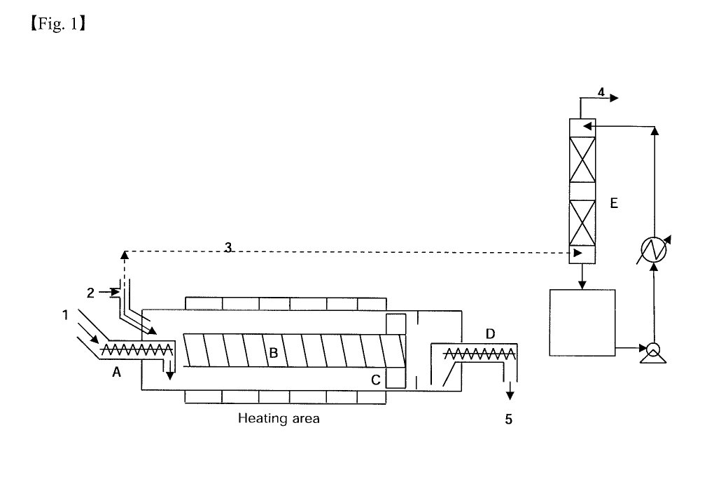

According to an embodiment of the present invention, a rotary kiln reaction facility as shown in FIG. 1 is used as a reactor for producing tetrafluorosilane gas continuously. In the present invention, solid raw materials such as fluoride source material and amorphous silica are fed into the reactor by using a screw (flow 1), and at the same time sulfuric acid is continuously fed into the rotary kiln reactor by using a metering pump (flow 2). In addition, an inner screw (B) may be placed inside the reactor to circulate solid reaction materials in the kiln and inhibit them from being conglomerated, by which the reaction efficiency can increase. The produced tetrafluorosilane is discharged through the sulfuric acid inlet out of the reactor (flow 3) as shown in FIG. 1, and the fluoride source material is converted to sulfate compound and discharged from the reactor by using the solid discharging screw (flow 5). The gaseous material produced by the reaction, which is a mixture gas of water, tetrafluorosilane and a small amount of HF, is transferred to the H₂SO₄ scrubber (E). In the H₂SO₄ scrubber, water and hydrogen fluoride (HF) are dissolved in sulfuric acid and removed. The tetrafluorosilane gas purified through the H₂SO₄ scrubber is then transferred to a storage tank (flow 4). The present invention has an advantage of eliminating loss of tetrafluorosilane since the removal of water and hydrogen fluoride in the H₂SO₄ scrubber inhibits tetrafluorosilane from being converted to hexafluorosilicic acid, silica gel and the like.

The present invention is explained in more detail by the following working examples and comparative examples. However, the scope of the present invention is not limited by the working examples.

### EXAMPLE 1

By using the rotary kiln reactor as shown in FIG. 1, tetrafluorosilane was produced continuously. The temperature of the reactor was elevated by directly using an LPG burner, and prior to use the solid raw materials were dried for 30 minutes in a calciner having an inside temperature of 350° C.

The dried raw materials of sodium aluminum tetrafluoride (6.87 kg/hr) and silica fume having an SiO₂ content of 90% (3.66 kg/hr) were fed into the reactor through the line (1) and at the same time, sulfuric acid having a concentration of 98% (10.7 kg/hr) was fed through the line (2).

The reactor was equipped with an inner screw therein for smooth agitation of the raw materials. Tetrafluorosilane gas was generated immediately after the feeding of the reactants. The gas discharged through the line (3) was passed through the H₂SO₄ scrubber and then collected. After maintaining the reaction for 12 hours, the products sampled from the H₂SO₄ scrubber and the final storage tank were analyzed. The analysis results are shown in Table 1 below.

### EXAMPLES 2 to 5

### Production of Tetrafluorosilane by Using Silica Fume

In Examples 2 to 5, the fluoride source materials were changed as shown in Table 1 below. As the raw material of silica, silica fume having an SiO₂ content of 90% (3.66 kg/hr) was used. The device and procedure of the production were the same as those of Example 1. After the 12-hour reaction, the generated gas was analyzed in the same manner as Example 1. The analysis results are shown in Table 1 below.

TABLE 1

| | Type and amount of | Type and amount of | Amount of | Yield of |
|---|---|---|---|---|
| | fluoride source (kg/hr) | silica (kg/hr) | sulfuric acid (kg/hr) | SiF₄ (%) |
| Example 1 | NaAlF₄: 6.87 | Silica fume: 3.66 | 10.70 | 85 |
| Example 2 | CaF₂: 8.51 | Silica fume: 3.66 | 10.70 | 93 |
| Example 3 | Na₃AlF₆: 7.67 | Silica fume: 3.66 | 10.70 | 82 |
| Example 4 | NaF: 9.156 | Silica fume: 3.66 | 10.70 | 83 |
| Example 5 | AlF₃: 6.14 | Silica fume: 3.66 | 10.70 | 82 |

### EXAMPLES 6 to 10

### Production of Tetrafluorosilane by Using Diatomaceous Earth

In Examples 6 to 10, the fluoride source materials were changed as shown in Table 2 below. As the raw material of silica, Diatomaceous earth having an SiO₂ content of 88% (3.74 kg/hr) was used. The device and procedure of the production were the same as those of Example 1. After the 12-hour reaction, the generated gas was analyzed in the same manner as Example 1. The analysis results are shown in Table 2 below.

TABLE 2

| | Type and amount of | Type and amount of | Amount of | Yield of |
|---|---|---|---|---|
| | fluoride source (kg/hr) | silica (kg/hr) | sulfuric acid (kg/hr) | SiF₄ (%) |
| Example 6 | NaAlF₄: 6.87 | Diatomaceous earth: 3.74 | 10.70 | 83 |
| Example 7 | CaF₂: 8.51 | Diatomaceous earth: 3.74 | 10.70 | 92 |
| Example 8 | Na₃AlF₆: 7.67 | Diatomaceous earth: 3.74 | 10.70 | 82 |
| Example 9 | NaF: 9.156 | Diatomaceous earth: 3.74 | 10.70 | 80 |
| Example 10 | AlF₃: 6.14 | Diatomaceous earth: 3.74 | 10.70 | 81 |

### EXAMPLES 11 to 15

### Production of Tetrafluorosilane by Using Cullet

In Examples 11 to 15, the fluoride source materials were changed as shown in Table 3 below. As the raw material of silica, cullet having an SiO₂ content of 71% (4.63 kg/hr) was used. The device and procedure of the production were the same as those of Example 1. After the 12-hour reaction, the generated gas was analyzed in the same manner as Example 1. The analysis results are shown in Table 3 below.

TABLE 3

| | Type and amount of | Type and amount of | Amount of | Yield of |
|---|---|---|---|---|
| | fluoride source (kg/hr) | silica (kg/hr) | sulfuric acid (kg/hr) | SiF₄ (%) |
| Example 11 | NaAlF₄: 6.87 | Cullet: 4.63 | 10.70 | 82 |
| Example 12 | CaF₂: 8.51 | Cullet: 4.63 | 10.70 | 91 |
| Example 13 | Na₃AlF₆: 7.67 | Cullet: 4.63 | 10.70 | 80 |
| Example 14 | NaF: 9.156 | Cullet: 4.63 | 10.70 | 80 |
| Example 15 | AlF₃: 6.14 | Cullet: 4.63 | 10.70 | 79 |

### EXAMPLES 16 to 20

### Production of Tetrafluorosilane by Using Kaolin

In Examples 16 to 20, the fluoride source materials were changed as shown in Table 4 below. As the raw material of silica, kaolin having an SiO₂ content of 80% (4.11 kg/hr) was used. The device and procedure of the production were the same as those of Example 1. After the 12-hour reaction, the generated gas was analyzed in the same manner as Example 1. The analysis results are shown in Table 4 below.

TABLE 4

| | Type and amount of | Type and amount of | Amount of | Yield of |
|---|---|---|---|---|
| | fluoride source (kg/hr) | silica (kg/hr) | sulfuric acid (kg/hr) | SiF₄ (%) |
| Example 16 | NaAlF₄: 6.87 | Kaolin: 4.11 | 10.70 | 82 |
| Example 17 | CaF₂: 8.51 | Kaolin: 4.11 | 10.70 | 90 |
| Example 18 | Na₃AlF₆: 7.67 | Kaolin: 4.11 | 10.70 | 82 |
| Example 19 | NaF: 9.156 | Kaolin: 4.11 | 10.70 | 82 |
| Example 20 | AlF₃: 6.14 | Kaolin: 4.11 | 10.70 | 81 |

### EXAMPLES 21 to 25

### Production of Tetrafluorosilane by Using Fumed Silica

In Examples 21 to 25, the fluoride source materials were changed as shown in Table 5 below. As the raw material of silica, fumed silica having an SiO₂ content of 98% (3.29 kg/hr) was used. The device and procedure of the production were the same as those of Example 1. After the 12-hour reaction, the generated gas was analyzed in the same manner as Example 1. The analysis results are shown in Table 5 below.

TABLE 5

| | Type and amount of | Type and amount of | Amount of | Yield of |
|---|---|---|---|---|
| | fluoride source (kg/hr) | silica (kg/hr) | sulfuric acid (kg/hr) | SiF₄ (%) |
| Example 21 | NaAlF₄: 6.87 | Fumed silica: 3.29 | 10.70 | 84 |
| Example 22 | CaF₂: 8.51 | Fumed silica: 3.29 | 10.70 | 93 |
| Example 23 | Na₃AlF₆: 7.67 | Fumed silica: 3.29 | 10.70 | 83 |
| Example 24 | NaF: 9.156 | Fumed silica: 3.29 | 10.70 | 81 |
| Example 25 | AlF₃: 6.14 | Fumed silica: 3.29 | 10.70 | 82 |

### EXAMPLES 26 to 30

### Production of Tetrafluorosilane by Using Fly Ash

In Examples 26 to 30, the fluoride source materials were changed as shown in Table 6 below. As the raw material of silica, fly ash having an SiO₂ content of 54% (6.09 kg/hr) was used. The device and procedure of the production were the same as those of Example 1. After the 12-hour reaction, the generated gas was analyzed in the same manner as Example 1. The analysis results are shown in Table 6 below.

TABLE 6

| | Type and amount of | Type and amount of | Amount of | Yield of |
|---|---|---|---|---|
| | fluoride source (kg/hr) | silica (kg/hr) | sulfuric acid (kg/hr) | SiF₄ (%) |
| Example 26 | NaAlF₄: 6.87 | Fly ash: 6.09 | 10.70 | 81 |
| Example 27 | CaF₂: 8.51 | Fly ash: 6.09 | 10.70 | 90 |
| Example 28 | Na₃AlF₆: 7.67 | Fly ash: 6.09 | 10.70 | 80 |
| Example 29 | NaF: 9.156 | Fly ash: 6.09 | 10.70 | 79 |
| Example 30 | AlF₃: 6.14 | Fly ash: 6.09 | 10.70 | 78 |

### EXAMPLES 31 to 35

### Production of Tetrafluorosilane by Using Slag

In Examples 31 to 35, the fluoride source materials were changed as shown in Table 7 below. As the raw material of silica, slag having an SiO₂ content of 35% (9.40 kg/hr) was used. The device and procedure of the production were the same as those of Example 1. After the 12-hour reaction, the generated gas was analyzed in the same manner as Example 1. The analysis results are shown in Table 7 below.

TABLE 7

| | Type and amount of | Type and amount of | Amount of | Yield of |
|---|---|---|---|---|
| | fluoride source (kg/hr) | silica (kg/hr) | sulfuric acid (kg/hr) | SiF₄ (%) |
| Example 31 | NaAlF₄: 6.87 | Slag: 9.40 | 10.70 | 81 |
| Example 32 | CaF₂: 8.51 | Slag: 9.40 | 10.70 | 89 |
| Example 33 | Na₃AlF₆: 7.67 | Slag: 9.40 | 10.70 | 81 |
| Example 34 | NaF: 9.156 | Slag: 9.40 | 10.70 | 80 |
| Example 35 | AlF₃: 6.14 | Slag: 9.40 | 10.70 | 78 |

### EXAMPLES 36 to 40

### Production of Tetrafluorosilane by Using Activated Clay

In Examples 36 to 40, the fluoride source materials were changed as shown in Table 8 below. As the raw material of silica, activated clay having an SiO₂ content of 75% (4.39 kg/hr) was used. The device and procedure of the production were the same as those of Example 1. After the 12-hour reaction, the generated gas was analyzed in the same manner as Example 1. The analysis results are shown in Table 8 below.

TABLE 8

| | Type and amount of | Type and amount of | Amount of | Yield of |
|---|---|---|---|---|
| | fluoride source (kg/hr) | silica (kg/hr) | sulfuric acid (kg/hr) | SiF₄ (%) |
| Example 36 | NaAlF₄: 6.87 | Activated clay: 4.39 | 10.70 | 84 |
| Example 37 | CaF₂: 8.51 | Activated clay: 4.39 | 10.70 | 92 |
| Example 38 | Na₃AlF₆: 7.67 | Activated clay: 4.39 | 10.70 | 83 |
| Example 39 | NaF: 9.156 | Activated clay: 4.39 | 10.70 | 82 |
| Example 40 | AlF₃: 6.14 | Activated clay: 4.39 | 10.70 | 83 |

### EXAMPLES 41 to 45

### Production of Tetrafluorosilane by Using Silica Gel

In Examples 41 to 45, the fluoride source materials were changed as shown in Table 9 below. As the raw material of silica, silica gel having an SiO₂ content of 90% (3.66 kg/hr) was used. The device and procedure of the production were the same as those of Example 1. After the 12-hour reaction, the generated gas was analyzed in the same manner as Example 1. The analysis results are shown in Table 9 below.

TABLE 9

| | Type and amount of | Type and amount of | Amount of | Yield of |
|---|---|---|---|---|
| | fluoride source (kg/hr) | silica (kg/hr) | sulfuric acid (kg/hr) | SiF₄ (%) |
| Example 41 | NaAlF₄: 6.87 | Silica gel: 3.66 | 10.70 | 85 |
| Example 42 | CaF₂: 8.51 | Silica gel: 3.66 | 10.70 | 93 |
| Example 43 | Na₃AlF₆: 7.67 | Silica gel: 3.66 | 10.70 | 83 |
| Example 44 | NaF: 9.156 | Silica gel: 3.66 | 10.70 | 82 |
| Example 45 | AlF₃: 6.14 | Silica gel: 3.66 | 10.70 | 84 |

### COMPARATIVE EXAMPLES 1 to 5

### Production of Tetrafluorosilane by Using Crystalline Silica Having a Particle Size of about 100 μm

Instead of silica fume as in Example 1, crystalline silica having a particle size of about 100 μm and an SiO₂ content of 98% or more was used as the raw material of silica. The various fluoride source materials as shown in Table 10 below and the crystalline silica were fed through the line (1) and at the same time, sulfuric acid having concentration of 98% (10.7 kg/hr) was fed through the line (2). After the 12-hour reaction, the generated gas was analyzed in the same manner as Example 1. The yields of tetrafluorosilane gas were 30 to 35% as shown in Table 10 below.

TABLE 10

| | Type and amount of | Type and amount of | Amount of | Yield of |
|---|---|---|---|---|
| | fluoride source (kg/hr) | silica (kg/hr) | sulfuric acid (kg/hr) | SiF₄ (%) |
| Com. Ex. 1 | NaAlF₄: 6.87 | 100 μm silica: 3.29 | 10.70 | 35 |
| Com. Ex. 2 | CaF₂: 8.51 | 100 μm silica: 3.29 | 10.70 | 35 |
| Com. Ex. 3 | Na₃AlF₆: 7.67 | 100 μm silica: 3.29 | 10.70 | 34 |
| Com. Ex. 4 | NaF: 9.156 | 100 μm silica: 3.29 | 10.70 | 32 |
| Com. Ex. 5 | AlF₃: 6.14 | 100 μm silica: 3.29 | 10.70 | 30 |

### COMPARATIVE EXAMPLES 6 to 10

### Production of Tetrafluorosilane by Using Crystalline Silica Having a Particle Size of about 20 μm

After milling of the crystalline silica having a particle size of about 100 μm in Comparative Example 1 to have a particle size of about 20 μm, the obtained crystalline silica having a particle size of about 20 μm was used as the raw material of silica. The device and procedure of the production were the same as those of Comparative Example 1. After the 12-hour reaction, the generated gas was analyzed in the same manner as Example 1. The yields of tetrafluorosilane gas were 35 to 40% as shown in Table 11 below.

TABLE 11

| | Type and amount of | Type and amount of | Amount of | Yield of |
|---|---|---|---|---|
| | fluoride source (kg/hr) | silica (kg/hr) | sulfuric acid (kg/hr) | SiF₄ (%) |
| Com. Ex. 6 | NaAlF₄: 6.87 | 20 μm silica: 3.29 | 10.70 | 37 |
| Com. Ex. 7 | CaF₂: 8.51 | 20 μm silica: 3.29 | 10.70 | 40 |
| Com. Ex. 8 | Na₃AlF₆: 7.67 | 20 μm silica: 3.29 | 10.70 | 37 |
| Com. Ex. 9 | NaF: 9.156 | 20 μm silica: 3.29 | 10.70 | 35 |
| Com. Ex. 10 | AlF₃: 6.14 | 20 μm silica: 3.29 | 10.70 | 35 |

According to Tables 1 to 11 above, it can be known that Examples 1 to 45 of the present invention produced tetrafluorosilane gas with high yields whereas Comparative Examples 1 to 10 produced tetrafluorosilane gas with low yields. In addition, in the examples of the present invention, discarded materials or by-products of other industrial processes such as cullet and silica fume could be used as raw materials to produce tetrafluorosilane by an environmentally friendly and economic process.

### EXPLANATION OF THE SYMBOLS IN THE DRAWINGS

A: Screw for feeding solid raw materials (silica, fluorinated compounds)
B: Inner screw
C: Spacer for inner screw
D: Screw for discharging solids
E: H₂SO₄ scrubber
1: Line for feeding fluorinated compounds and silica
2: Line for feeding sulfuric acid
3: Line for discharging the mixture gas of tetrafluorosilane, water and HF
4: Line for discharging SiF₄ after removal of water
5: Line for discharging solid sulfate compound

1. A method of producing tetrafluorosilane comprising the steps of:
(1) reacting in a single reactor (i) a fluoride source material capable of reacting with sulfuric acid to generate hydrogen fluoride (HF), (ii) amorphous silica and (iii) sulfuric acid; and
(2) passing the obtained gaseous product of step (1) through a H₂SO₄ scrubber.

2. The method of producing tetrafluorosilane according to claim 1, wherein the fluoride source material is selected from the group consisting of sodium aluminum tetrafluoride, chiolite, cryolite, calcium fluoride, sodium fluoride, aluminum fluoride and mixtures thereof.

3. The method of producing tetrafluorosilane according to claim 2, wherein the sodium aluminum tetrafluoride is a by-product generated during a process for preparing monosilane by reacting tetrafluorosilane gas with sodium aluminum tetrahydride as a reducing agent, or a product prepared by mechanically milling a mixture of aluminum trifluoride and sodium fluoride.

4. The method of producing tetrafluorosilane according to claim 1, wherein the amorphous silica is selected from the group consisting of cullet, Diatomaceous earth, silica fume, kaolin, fumed silica, fly ash, slag, activated clay, silica gel and mixtures thereof.

5. The method of producing tetrafluorosilane according to claim 1, wherein the reactor is a rotary kiln reactor.

6. The method of producing tetrafluorosilane according to claim 1, wherein the reaction temperature is 150 to 800° C. and the operation pressure in the reactor is at least −1,000 mmH₂O.

7. The method of producing tetrafluorosilane according to claim 1, wherein the operation temperature of the H₂SO₄ scrubber is 10 to 150° C.

8. The method of producing tetrafluorosilane according to claim 1, wherein the gaseous product is transferred from the reactor to the H₂SO₄ scrubber while maintaining the temperature at its dew point or higher.
